(19) United States
(12) Patent Application Publication
(10) Pub. No.: US 2002/0066071 A1
(43) Pub. Date: May 30, 2002

(54) LOCAL ENVIRONMENT FOR INTEGRATED MULTIPLE-TIER CLIENT-SERVER CONCURRENT PROGRAM DEVELOPEMENT

(76) Inventors: SING-BAN ROBERT TIEN, SARATOGA, CA (US); SHIH-GONG LI, SAN JOSE, CA (US); YUN-YONG SHEN, SAN JOSE, CA (US); TU-HSIN TSAI, SARATOGA, CA (US)

Correspondence Address: Mr. Jordan A. Sigale, SONNENSCHEIN NATH & ROSENTHAL, 8000 Sears Tower, 233 South Wacker Drive, Chicago, IL, 60606-6404, US

(21) Appl. No.: 09/258,050

(22) Filed: Feb. 25, 1999

(51) Int. Cl. G06F 9/45

(52) U.S. Cl. 717/102; 717/138

(57) ABSTRACT

The present invention discloses a the present invention discloses an integrated program development environment (IDE) for carrying out concurrent program development tasks on a local station for programs executable on a multiple-tier networked client-server system with multiple tiers of client-server stations. The development environment includes a development-environment emulator for emulating program execution environments in each of the multiple tiers of networked client-server stations. The integrated program development environment further includes a communication emulator for emulating networked communications carried out between the multiple tiers of networked stations performed in executing the programs executable on the multiple tiers of networked client-server system. The development-environment emulator further includes a tier-to-tier data-file compatibility handler for processing data-files generated from each of the multiple-tier of networked stations to carry out compatible data-file transmissions and receptions with another one of the multiple tiers of networked stations. In an alternate preferred embodiment, the integrated program development environment (IDE) further includes a graphic user interface (GUI) for receiving a user's input and command for carrying out the concurrent program development tasks. In another preferred embodiment, the integrated program development environment further includes a debugger for interfacing with the development-environment emulator for executing an emulated debugging stepping-through process for programs developed for execution on the multiple-tier client-server stations. In another preferred embodiment, the tier-to-tier data-file compatibility handler for processing data files generated from each of the multiple tiers of networked stations is a virtual machine extension (VMX).

This Application claims a Priority Filing Date of Feb. 26, 1998 benefited from a previously filed Provisional Application No. 60/076,084 by the same inventors as the present Formal Patent Application.

### BACKGROUND OF THE INVENTION

1. Field of the Invention

This invention relates generally to an integrated development environment (IDE) for developing executable programs for a multiple-tier network system. More particularly, this invention relates to a local environment provided for integrated and concurrent program development and debugging for executable programs on client-server stations of a multiple-tier client-sever network system.

2. Description of the Prior Art

Program development for a typical two-tier client-server system and debugging processes via the Internet or Intranet connections are difficult and often-time frustrating. The programs for execution on each of the client-server stations are developed on that particular client-server station based on a set of presumed activities involving client-server communications and data-file transmissions taking place during program execution. Actual testing and debugging processes are then carried out remotely through the network connections after the entire program development efforts for both the client and server are completed. The efforts of program development are therefore fragmented and subjected to many unknowns arising from surprises in real network program execution and interactions.

Furthermore, remote and interactive debugging and program development over current Internet or Intranet systems are limited by several intrinsic difficulties. The difficulties arise mainly from the basic configuration of data object distribution over the network where the network servers are employed as depository sites of a pool of generic data objects. To carry out a remote debugging operation, a user has to rely on an object-to-object invocation by sending an object specific proxy to a server. Such processes are often inconvenient, time consuming and more complicate due to the fact that more client-server interactions are required before a debugging operation can be completed. Furthermore, since the data-objects included in the server pool are generic in nature and not project-specific, instantiation of such generic data object over the server side requires larger amount of project related parameters to be transferred over the network to the server every time a remote debugging process is performed. The remote debugging processes are also more time and resource consuming due to the need to process more project related parameters to instantiate a generic data object. A brief review of several remote debugging developing platforms currently available in the marketplace clear shows these difficulties and limitations still encountered by those of ordinary skill in the art in attempt to carry out a remote debugging task.

There are several client-server platforms currently available in the marketplace for performing the tasks of interactive client-server debugging. One of such platforms is Netscape's LiveWire written in JavaScript (LW/JS). Netscape's LiveWire however has many limitations. First of all, it relies on a system object provided by the session manager objects to retain persistent state. If a user wants to keep track of the states not provided by the system object, special custom client objects, written in JavaScript, must be used to carry out the task of state retention. Due to the fact that JavaScript is only a scripting language of limited capabilities, LiveWire does not provide an open platform to import powerful data objects written in C and C++ languages. The usefulness of Netscape's LiveWire is therefore greatly limited. Also, LiveWire has three different ways to index a client state on the server side. An application programmer has to check if the methods of state indexing are changed by the web administration. In case, the web administration inadvertently changes the state indexing method, the application programs may not function properly. The component model in its architecture further limits applications of LiveWare. Specifically, it is very inflexible to introduce a third party component for web application on the server side. Lastly, LiveWire is an HTML based system. An HTML-based system has many drawbacks, which will be further discussed below. In addition to these problems, a practical inconvenience exits due to the fact that a user on the client side may exit by simply quitting out from browser, while the server is not notified. A timer has to be maintained on the server side such that a set of specific user related data-objects are deleted after a certain period of time without access from a particular user.

Microsoft ASP is another product in this category which provide more debugging facilities. However, the debugging of the client portion and the server portion are still separated. Therefore it still requires the AP to know both the client part and server administration in order to perform development and debugging. This is often cumbersome since an AP will have to manipulate a client debugging process and a server side debugging process with client browser running and also server process ongoing. Besides, Microsoft's debugging is only available on Windows platform limiting the choice of server platforms. Most importantly adopting this approach leave out the most commonly production platform namely Unix.

Lately there are many “Application Server” products available in the market, for example Sun's Netdynamice application server. These application servers increase the complexity of server side setup, administration and management. They usually runs behind a web server and process the request intercepted from the web server.

Each of these products is quite unique and requires quite different programming skill and debugging capability of an AP. It often requires in depth knowledge of the application server and its programming model and also the administrative aspect of the server. Debugging facilities are again separated into client and server portion if it is provided at all. (Some of them do not have debugging and development tool built with it and rely on 3rd party tools that make the development process even more complex such as Netscape's NAS a.k.a KIVA.)

One of the key concepts of this invention is to separate the administrative burden of a server and its underlying operating system from the development process and leave that to the system administrator. By building an emulator server process into the development tool and integrated into a single development environment, an AP do not have to worry about the administrative aspect of the server and client and can concentrate on the application logic both the client side and the server side. The development environment guarantees that once the development is completed and debugged within the environment through the deployment process the application will be run correctly assuming the server administrative has correctly set up the server. Through this, the hurdle of client-server development is greatly reduced and the development cycle is also cut down drastically increasing the productivity.

Also available on the market is Microsoft's ActiveX Server Page/Visual Basic Script (ASP/VBS) for a user to perform remote scripting tasks by applying scriptable Java applets using high level scripting language. The platform offers the benefits that scripting program and prototype can be developed rapidly by employing high level scripting languages. Application can be easily extended with Java based components wherein new components can be easily plugged. The Java object can also be downloaded and secured by sandbox security model and the client-server interactions can be carried out through open Web protocol and supported by most of the fire walls and network configurations currently available. Microsoft's ASP provides similar types of construct for persistent state across the requests for the application objects and the sever objects. A separate application-object and a sever-object are employed to maintain persistent state retention across multiple requests. Microsoft's ASP further includes a development tool, i.e., InterDev, which is provided to include a debugging capability by stepping through the script codes. Microsoft's ASP provides a more flexible object oriented environment for a developer to create any Active-X objects in script. However, Microsoft's ASP is still limited by its HTML page-by-page process as will be further discussed below. Because of this limitation, practical real-time interactive debugging over a client server network configuration would be very difficult to carry out.

Both of above platforms for network program developments provide some scripting capabilities. However, the program development processes are carried out over the network as HTML-based applications. These platforms are based on presumed operational modes originally designed for document retrieval and searching for references. Due to the HTML operational modes, great deals of inflexibility and wastes of network and processor resources are encountered when program-development tasks are performed on these conventional platforms. On the server side, the server first processes the scripts to generate an HTML page. The HTML page is then sent to client's HTML agent, e.g., HTML browser such as Netscape Navigator. Every time when a request is generated by a client, this whole process is repeated over again and the client has to change its HTML page and thus losing the view of all the data entered due to the very limited graphic user interface provided by the HTML-based browser. Most the processes carried out by the server are redundant and waste of processing resources due to the fact that only few data items are changed on the client side for each new request. The redundant processes slow down the client-server interactions. Also, the interactions between the client and the server depends entirely on the component and objects and a programmer has no direct control from one side, e.g., either the client or the server side, to the other. For these reasons, real-time interactive client-server debugging process for program development is very difficult to realize on a platform currently available in the market.

Please refer to FIG. 1 for a system block diagram of the network configuration employed by these platforms for remote scripting. In the client side, when a remote scripting is required for executing a step of object.method(x), a separate object or component is generated which then sends out a proxy to interact with another object or component on the server side. Because of this interaction mode, a programmer is provided with very limited information for debugging and complex tracing efforts have to be conducted to determine status of program execution during a debugging process.

In addition to the above difficulties in testing and debugging processes, the program development activities have to be performed at several operational environments. There is no integrated development environment for networked client-server program developments that would allow for local concurrent program developments. As discussed above, one major difficulty is the fact that current client-server interactions are carried out based on HTML-page operations. The interaction mode is still based on a document-retrieval page-by-page operation. The data-file transmissions between the client and server are very inefficient and wasteful. Limited by the slow and inefficient data-file transmissions over the network, concurrent and integrated program development either locally or over the network system would be very difficult to carry out.

Therefore, a need still exists in the art of networked computer programming to provide a new and improved system and method such that a user can more flexibly and effectively carry out concurrent program development. Also, in this new and improved system configuration, local or remote interactive debugging can be more conveniently carried out. Preferably, such improved system would also reduce the size and the required interactions between the server and the client for performing the remote debugging. Thus, the data traffic load over the network system can be reduced and the wait-time for completing an application program involves the remote scripting operations can be significantly improved and the applications can be more expeditiously performed. More importantly, direct control have to be provided to a programmer for invocation and execution of a remote event such that convenient and flexible debugging process can be performed without requiring extra time spent in detail tracing efforts.

### SUMMARY OF THE PRESENT INVENTION

It is therefore an object of the present invention to provide a network-computing platform, which can provide a truly non-HTML-based concurrent and integrated client-server program development environment. Multiple local client-servers emulators are implemented to carry out local concurrent program development for on execution on multiple-tier of client-server stations. Local emulated debugging process or real-time remote interactive client-server debugging capabilities are also provided such that the aforementioned difficulties and limitations in the prior art can be overcome.

Specifically, it is an object of the present invention to provide a novel integrated program development environment for local concurrent program development for programs executable on multiple-tier client-server stations. Local emulators of client-server program execution environments and communication emulator are implemented with a novel tier-to-tier data-file compatibility handler for each of the client-server stations to achieve the purpose of local concurrent program development, testing and debugging processes.

Another object of the invention is to provide a novel integrated program development environment for local concurrent program development for programs executable on multiple-tier client-server stations. The transmission and reception of data-files are emulated as a Java-based virtual machine extension (VMX) to perform symmetrical client-server VMX data-object attachment-detachment functions. Standardized and well-defined data-files can be convenient interchanged and efficiently processed for program development emulation and debugging.

Another object of the invention is to provide an object-oriented network platform with application-development debugging tools applying Java-based Web communication. A Java application can be executed on the client side for sending a request to a server to retrieve required data objects. The transmission of request and retrieved data objects can be carried out without relying on an HTML-based Web browser such that a real-time client-server debugging process can be more effectively performed.

In a preferred embodiment, novel object-oriented network system is implemented. The system is provided with symmetrical client-server VMX data-object attachment-detachment functions. The scriptable applications are partitioned into smaller connectable data objects including internal and external types of data objects. Special description files are employed for sending and receiving project specific data objects for transfer over the network to accomplish data object attachment and detachment. The data attachment and detachment operations are achieved by simple memory copy operations. Event instantiation can be accomplished by a simple project name recognition followed by a block memory copy operation thus greatly simplify the remote scripting processes. By implementing such a VMX system in a multiple-tier client-server system, concurrent program development environment can be easily emulated with simplified standard data-file interchanges for multiple-tier program execution.

Briefly, in a preferred embodiment, the present invention discloses an integrated program development environment (IDE) for carrying out concurrent program development tasks on a local station for programs executable on a multiple-tier networked client-server system with multiple tiers of client-server stations. The development environment includes a development-environment emulator for emulating program execution environments in each of the multiple tiers of networked client-server stations. The integrated program development environment further includes a communication emulator for emulating networked communications carried out between the multiple tiers of networked stations performed in executing the programs executable on the multiple tiers of networked client-server system. The development-environment emulator further includes a tier-to-tier data-file compatibility handler for processing data-files generated from each of the multiple-tier of networked stations to carry out compatible data-file transmissions and receptions with another one of the multiple tiers of networked stations. In an alternate preferred embodiment, the integrated program development environment (IDE) further includes a graphic user interface (GUI) for receiving a user's input and command for carrying out the concurrent program development tasks. In another preferred embodiment, the integrated program development environment further includes a debugger for interfacing with the development-environment emulator for executing an emulated debugging stepping-through process for programs developed for execution on the multiple-tier client-server stations. In another preferred embodiment, the tier-to-tier data-file compatibility handler for processing data files generated from each of the multiple tiers of networked stations is a virtual machine extension (VMX).

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a functional block diagram to show a system configuration of a conventional network system and the scripting functions performed thereon;

FIG. 2 is a functional block diagram to show a system configuration of an integrated program development environment (IDE) for concurrent multiple-tier client-server program-development;

FIGS. 3A and 3B are functional block diagram showing a system configuration of a network implemented with a virtual machine extension (VMX) of the present invention;

FIG. 4A illustrates the structure of a conventional encapsulated data object of a object oriented (OO) data object;

FIG. 4B illustrates a new structure of a novel network OO data object of the present invention;

FIG. 5A is a flow chart showing the functional steps carried out by VMX to create an object instance in run time;

FIGS. 5B and 5C are respectively Intertop Applet description file format and Intertop component TYPE INFO file structure for data object identification and association;

FIG. 6 is a block functional diagram of FIG. 2 implemented with a VMX of this invention; and

FIG. 7 shows the interactive client/server debugging in an iXpresso environment of this invention implemented with Java-based VMX.

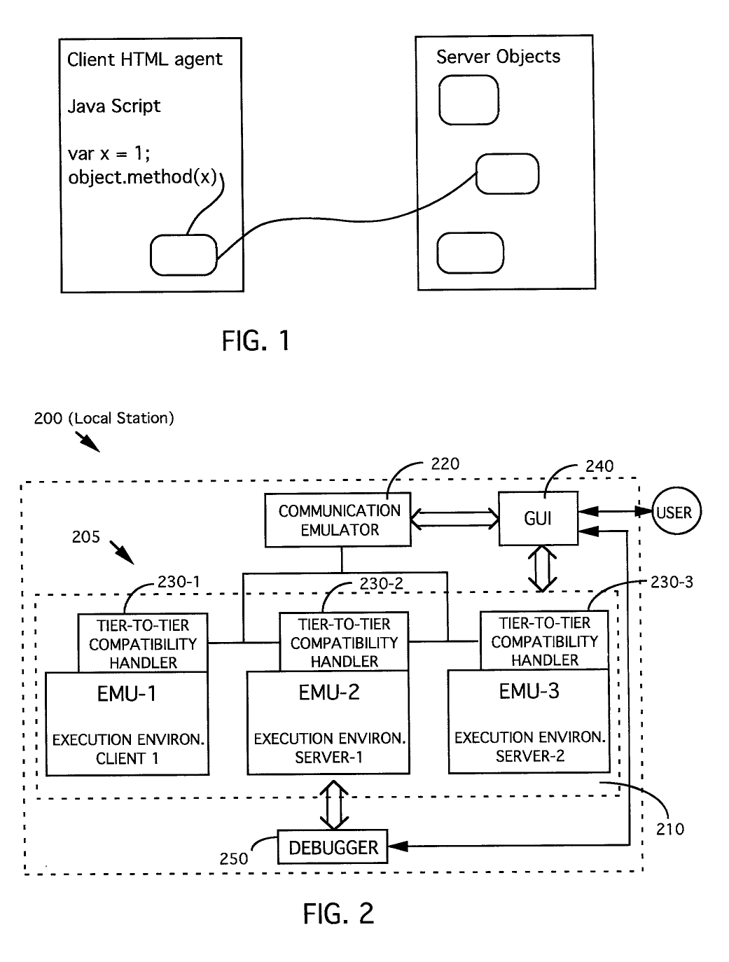

### DETAILED DESCRIPTION OF THE PREFERRED EMBODIMENT

FIG. 2 is a functional block diagram for showing the configuration of an integrated development environment (IDE) 205 for carrying out concurrent program development tasks on a local station 200 for programs executable on a multiple-tier networked client-server system. The program development is performed for a networked client-server system that has three tiers of client-server stations, e.g. Client-1, Server-1 and Server-2. The IDE can be employed for as many client-server tiers as necessary and practical. A three-tier client server system as shown in FIG. 2 is for illustration purpose only. The number of client-server tiers is not a limitation for implementation of this invention. The integrated development environment includes a development-environment emulator 210. This development-environment emulator 210 includes EMU-1, EMU-2, EMU-3 for emulating program execution environments in each of the three tiers of networked client-server stations, e.g., Clinet-1, Server-1, and Server-2 execution environments respectively. Namely, EMU-1 emulates program execution environment of Client-1, EMU-2 emulates program execution environment of Server-1 and EMU-3 emulates program execution environment of Server-2.

The multiple-tier program development environment further includes a communication emulator 220 for emulating communications carried out between the multiple tiers of networked stations performed in executing the programs executable on the multiple tiers of networked client-server system. The communication processes take place between Client-1, Server-1, and Server-2 when the application programs are executed in each of these multiple-tier client-server stations are emulated by the communication emulator 220. The development-environment emulator 210 further includes a tier-to-tier data-file compatibility handler, e.g., 230-1, 230-2 and 230-3 for EMU-1 to EMU-3 respectively. The compatibility handler is implemented to process data files generated from each of the multiple tiers of networked stations, e.g., Clinet-1, Server-1, and Server-2. After the compatibility handler processes the data-files generated by each of these multiple-tier client-server stations, compatible data-file transmissions and receptions with another networked station can be flexibly and conveniently performed.

The integrated program development environment (IDE) further includes a graphic user interface (GUI) for receiving a user's input and command for carrying out the concurrent program development tasks. This GUI is a user-friendly, window-based type GUI. Flexible drag and drop operations can be easily accomplished by regular computer-mouse operations. The user-friendly GUI also provides script editors and attribute editors for editing script files and attribute files to be applied as part of tier-to-tier data-file compatibility handler data-files as described below. The integrated program development environment (IDE) 205 further includes a debugger 250. The debugger 250 interfaces with the emulator 210 to carry out concurrent testing and debugging processes. Under the command of the user, the debugger can activate the emulator 210 to perform a step-through testing run and perform an intermediate result checking process to debug the programs. The debugging processes can be performed concurrently with execution of program running on EMU-1 to EMU-3. The programs developed by using this multiple-tier client-server integrated development environment can therefore conveniently tested and debugged in the multiple-tier client server IDE.

One of the major difficulties encountered in providing a local environment for integrated and concurrent program development for a multiple-tier client work station is resolved by implementation of a special tier-to-tier data-file compatibility handler, e.g., handlers 230-1 to 230-3. As discussed above, the HTML-based client-server interactions, data-files are transmitted for updating HTML-pages processed by a browser. Such data-files provide very limited information that would be useful for concurrent program development. For the purpose of providing concurrent and integrated program development environment, this invention implements an event-driven data-object attachment-detachment processing means, e.g., a virtual machine extension (VMX) processing means, as a special tier-to-tier data-file compatibility handler. In order to fully understand the advantages of this invention, a detail description of this VMX processing means is provided below.

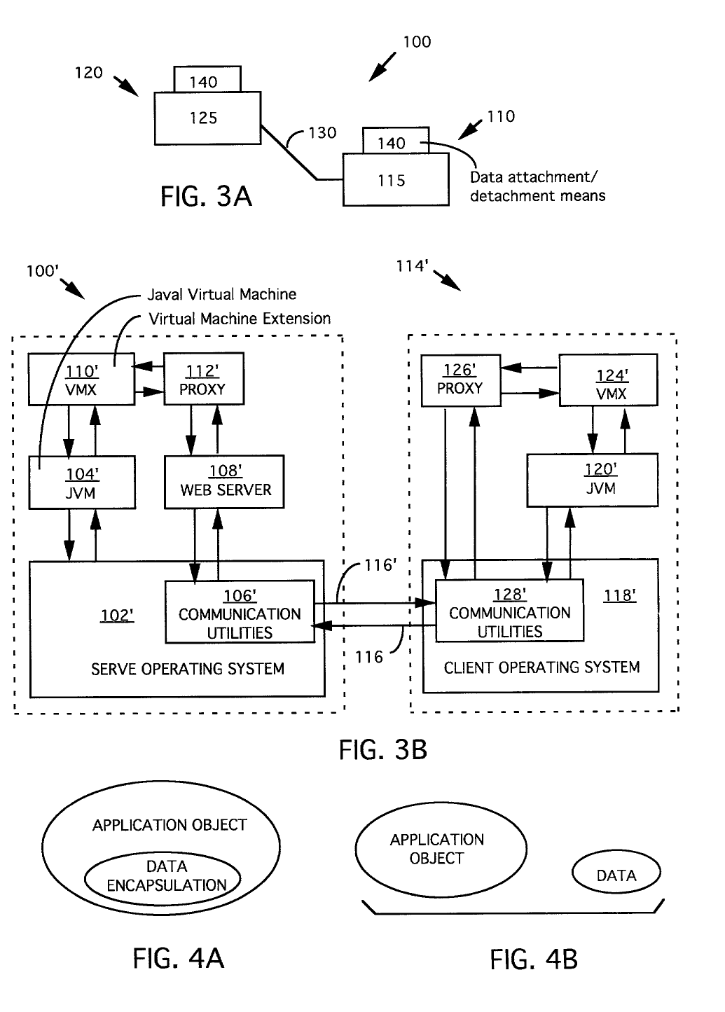

Please refer to FIG. 3A for illustrating the configuration of a network system 100 of the present invention. The network system 100, e.g., an Internet or an Intranet system typically includes a client 110 and a server 120 interconnected by network communication lines 130. The client 110 and the server 120, each has a main data handling/processing system 115 and 125 respectively. According to the present invention, the client 110 and the server 120 each further includes an event-driven data-object attachment-detachment processing means 140. One example of implementation for this event-driven data-object attachment-detachment processing means 140 is a virtual machine extension (VMX) processing means which will be further described later in more specific details. This event-driven data-object attachment-detachment processing means 140 responds to the data-object received from the network according to the object identification and object type of each data-object to perform a series of event driven data-object attachment or detachment actions. The results of the attached or detached data objects are then transferred to the main data handling/processing system 115 and 125 to be further processed.

Referring to FIG. 3B for a specific embodiment of the present invention where a virtual machine extension (VMX) is implemented in current Internet or Intranet network systems. The network system, implemented with Java virtual machine (JVM), includes a server 100′ and a client device 114′ communicated with each other by employing communication utilities 106′ and 118′. The server 100′ and the client device 114′ are under the command and control of a server operating system 102′ and a client operating system 118′ respectively wherein each includes a Java virtual machine (JVM) 104′ and 120′ which includes a Web server therein. The server 100′ further includes a web server 108′ which communicates with a VMX 110′ of the present invention via a proxy 112′. Similarly, the client device 114′ includes a VMX 124′ which communicates with the communication utilities 128′ via another proxy 126′.

In the present invention, new designs to provide novel data structures are disclosed to take advantage of the benefits of using the basic concepts of the object-oriented (OO) programming techniques. The object-oriented techniques implemented in this invention provide the convenience of object attachment and detachment, while maintaining separation of data from the functional units to reduce the load of network data communication. Functional units of “Applets” which are commonly used do not have to be redundantly stored. By separating the common functional units form the data that are user specific, data transfer requirements can be reduced.

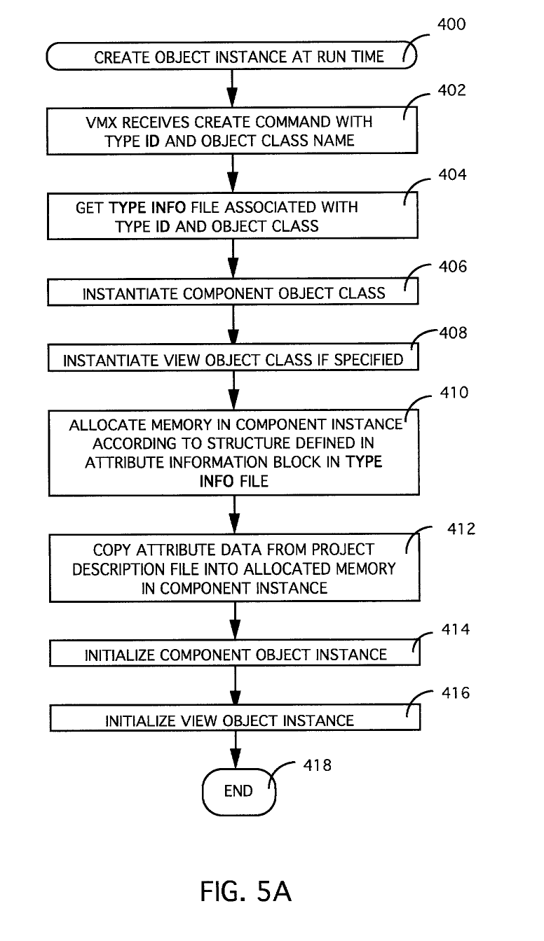

FIGS. 4A and 4B illustrate the basic concept employed in this invention. In FIG. 4A, typical 00 structure for an application is shown where the application object is encapsulated with data as one single “encapsulated object”. For the encapsulated data, each data item must have a pair of member functions for get and set the data. In this invention, as shown in FIG. 4B, the application object is separated from the data object as an integrated block of memory. Because the data are integrated and stored in one single memory block, only one pair of get and set functions are required to retrieve and use the data. In this single block of memory for data storage, the data are stored according to pre-designated indexes and the index of each data is stored at a object type information file which is pre-loaded in a virtual machine extension (VMX) of the present invention. With the application object separated from the data object as that shown in FIG. 4B, the amount of data transferred over the network is reduced. According to the data attachment-detachment techniques of the present invention, the iplet, i.e., the “Intertop Applet”, which is transferred over the Internet as a script file is much smaller. Because the generic functional units which can be commonly applied are stored as attachable Applets and are not transferred. Only the data items related to project specific scripting event at run time are transferred. In additional to achieving a reduction of data transfer load, the project specific scripting activities are more effectively and efficiently carried out because the instantiation is much simplified by performing a memory block copy such that savings of network resources are also accomplished.

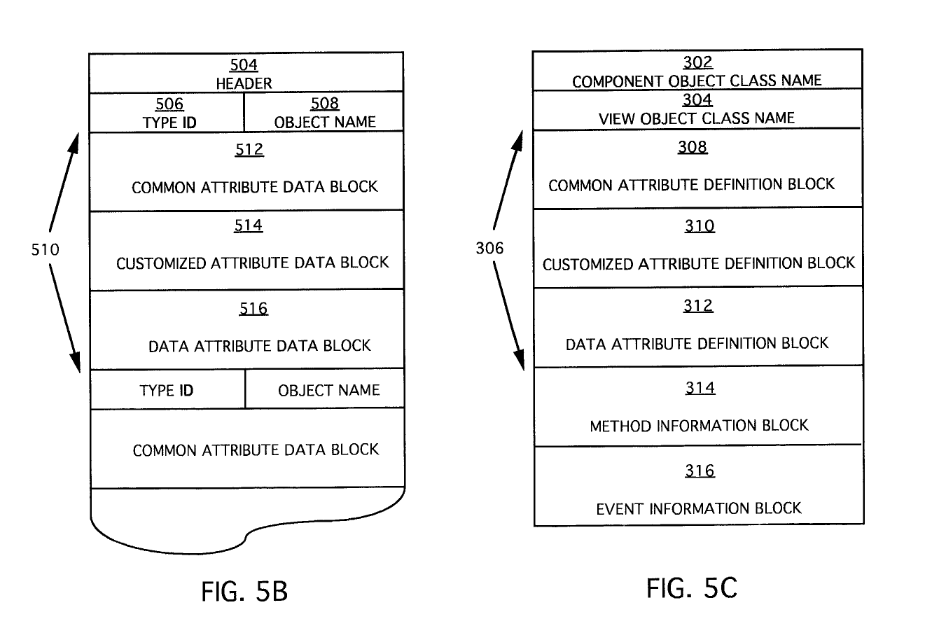

By separating the data objects as that shown above, the structure of each data object is further defined such that the data objects, which are transferred over the network, can be conveniently attached and detached. Referring to FIG. 5A for the functional steps performed by the virtual machine extension (VMX) to create an object instance at run time (Step 400). A command to “create object instance” is received from the network by the VMX (step 402). A data object as that shown in FIG. 5B is also received by the VMX along with the command to create an object instance. The “type ID” and the “object name” is extracted by the VMX to get the “TYPE INFO” file associated with the type ID and object class. FIG. 5C shows the “TYPE INFO” file structure and TYPE INFO files have been pre-loaded into the VMX. The VMX then perform a task to instantiate component object class (step 406) based on the component object class name contained in the TYPE INFO. According to the object type provided by the object type ID, a task to “instantiate a view object class” is performed (step 408) if a view object instance exists in the TYPE INFO. The VMX further allocates memory space in component instance according to the structure definitions provided in attribute information blocks, i.e., common attribute definition block 308, customized attribute definition block 310, and data attribute definition block 312, as specified in the TYPE INFO file. The attribute data, i.e., the common attribute data block 512, the customized attribute data block 514, and the data attribute data block 516, are then copied from the incoming iplet description file, to allocate memory in the component instance (step 412). The VMX then initializes the component object instance (step 414) and the view object instance (step 416) to complete the creation of the object instance at run time for the incoming iplet (step 418). As described above, the object instance at run time is created by the VMX then VMX also performs a series of type and object class identifications, memory allocations, and data copying actions. The data attachment operations are performed by the VMX to generate object instance that is ready to be further processed by client's JVM and operating system carry out functions defined by the object instances so created.

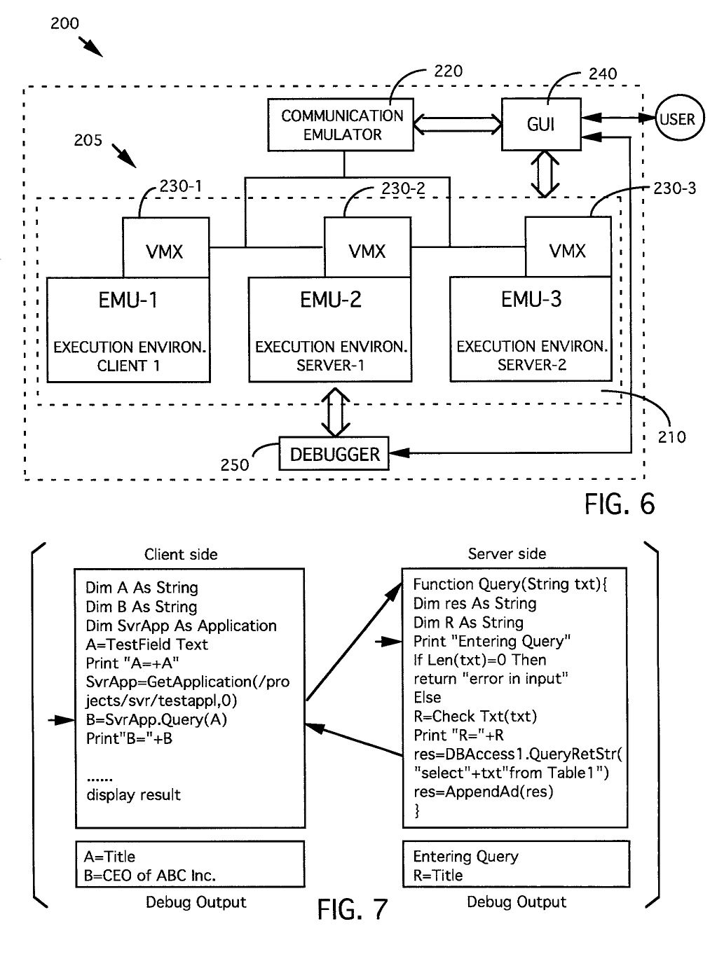

Referring back to FIG. 2 for the tier-to-tier data-file compatibility handler 230 to 230-3. For each of these handlers 230-1 to 230-3, a VMX as described above is implemented. FIG. 6 shows such a local concurrent IDE where each of the emulators EMU-1 to EMU-3 now includes a VMX system. The VMX system handles the data-object transmission and reception with a standardized description file and data-object files with well defined information relating to standard data-types, data-structure and operations to be performed on each data object By simplifying the data transmission and reception, and by accelerating the processes by data block attachment and detachment actions, the tasks performed by the tier-to-tier data-file compatibility handler become very simple and easy. The basic boundary conditions for setting up emulator 210 to emulate the execution environments of multiple tiers of client server are therefore standardized and well defined. Because of the standardized and simplified process and data-file structures for data-file transmission and reception, a concurrent development environment between multiple client-server stations can be more conveniently established. Complexities relating to different file structures and individual processes for each different data-files generated from tier-to-tier can therefore be eliminated.

An integrated program development environment (IDE) as described above is now provided in a product specifically named as “iXpresso”. The development environment provided by iXpresso is truly a Java component-based, non-HTML development environment. In an iXpresso environment, a client is running a Java application on the client side. Every time a request is transmitted to a server, only a relevant data-item is returned for updating a data field. No update is performed for client-server interface except the necessary part that new data are required. The server does not generate an entire page for refreshing a client-server interface as that usually performed in the HTML-page based operations. Savings are achieved for the client-server processing power and transmission of data.

For a project running on a client-server station, there are two kinds of relationships between every two components employed by the project. These two relationships are the spatial relationship and a semantic relationship. The spatial relationship refers to the positional and parent-child for visual components. One example of a positional relationship is a button with respect to a list box for positional placement. Another example may be a button with respect to a frame for patent-child relationship. The semantic relationship has to do with how component actions are tied together. For example when a button is clicked, an event handler is activated to copy the content of a text field and show the content on a label or sends it to a server. In iXpresso, these relationships are provided in two ways. The binary formats are employed to represent the spatial relationship such that spatial efficiency can be achieved to reduce the network traffic. The semantic relationship is provided by a script code, i.e., a high level language, which provides information of the activities to be engaged when particular event occurs. With VMX implemented on the client side, the itp files are processed to identify the project based on the spatial relationship. The client station is also able to intercept events and dispatch the event to proper event handler based on information contained in the itp files.

With a network system and data object distributions described above and as implemented in iXpresso, the tasks of a client-server development/debugging are greatly simplified. An example is shown in FIG. 7 for illustrating a client/server program development. A program develop can interface with a station on the client side and trace step-by-step, run break points and watch the debugging messages and the event script and the server event script code. When a client event code performs a remote scripting to a server function, the server script code debugger will stop at a preset break point. A program developer can step, trace, stop and run the server side script code. When the client gets the return messages, a developer can continue the debugging process on the client side. This is achieved because in an iXpresso environment, uniform client-server architecture are setup in Java and embedded the same VMX processes.

FIG. 7 shows a typical client sever development/debugging scenario. After completing the client script and the server script in two different windows as that shown in FIG. 7, a programmer is provided with an option to switch to a test/debug mode. With user-friendly window-based GUI, a simple clicking on a test/debug selection in a pull-down manual can carry out this mode switch action. A debug routine then guides the program developer to step through the code. When a call to a server function “Query” is encountered in stepping through the code on the client side, the server starts to step through the code of the function “Query” to produce an output of the results of the debugging processes from the server side script. If there is a programning error, a program developer is provided with sufficient information and opportunity to correct the error and test again. A programmer developer is not required to exit from the programming development mode for the purpose of entering into a operation environment on the side behind the Web server to conduct the test/debugging procedures. Or, the other hand, when a programmer is already in a server-environment looking at the results of server-traces, unlike the conventional development platforms, there is no requirement to exit from the server environment in order to examine the client side results. True interactive real-time client-server debugging capabilities are therefore provided by this invention. Such flexibility and freedom are not feasible for a conventional system due to facts that client-server environments are complex and heterogeneous. Even with the advancements made by Web application leading to a simplified client-server interaction, true interactive client-server debugging for program development is still not practical due to the page-oriented interactions as discussed above.

The difficulties encountered in the prior art are resolved by taking advantage of the uniformity of data structure and simplified client-server data exchanges by using the data object structures as iplet of this invention. By implementing VMX for both the client and the server, it is possible to integrate the program development with interactions between a client and a server as an Integrated Development Environment (IDE).

Therefore, the present invention provides a network-computing platform, which can allow a truly non-HTML-based concurrent and integrated client-server program development environment. Multiple local client-servers emulators are implemented to carry out local concurrent program development for on execution on multiple-tier of client-server stations. Local emulated debugging process or real-time remote interactive client-server debugging capabilities are also provided such that difficulties and limitations in the prior art are overcome. Specifically, local emulators of client-server program execution environments and communication emulator are implemented with a novel tier-to-tier data-file compatibility handler for each of the client-server stations to achieve the purpose of local concurrent program development, testing and debugging processes. The transmission and reception of data-files are emulated as a Java-based virtual machine extension (VMX) to perform symmetrical client-server VMX data-object attachment-detachment functions. Standardized and well-defined data-files can be convenient interchanged and efficiently processed for program development emulation and debugging. Also, a Java application can be executed on the client side for sending a request to a server to retrieve required data objects. The transmission of request and retrieved data objects can be carried out without relying on an HTML-based Web browser such that a real-time client-server debugging process can be more effectively performed.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An integrated program development environment (IDE) for carrying out concurrent program development tasks on a local station for programs executable on a multiple-tier networked client-server system with multiple tiers of client-server stations, the development environment comprising:
a development-environment emulator for emulating program execution environments in each of said multiple tiers of networked client-server stations;
a communication emulator for emulating communications carried out between said multiple tiers of networked stations performed in executing said programs executable on said multiple tiers of networked client-server system; and
said development-environment emulator further includes a tier-to-tier data-file compatibility handler for processing data files generated from each of said multiple tiers of networked stations for compatible data-file transmissions and receptions with another one of said multiple tiers of networked stations.

2. The integrated program development environment (IDE) of claim 1 further comprising:
a graphic user interface (GUI) for receiving a user's input and command for carrying out said concurrent program development tasks.

3. The integrated program development environment (IDE) of claim 1 further comprising:
a debugger for interfacing with said development-environment emulator for executing an emulated debugging stepping-through process for programs developed for execution on said multiple-tier client-server stations.

4. The integrated program development environment (IDE) of claim 1 wherein:
said tier-to-tier data-file compatibility handler for processing data files generated from each of said multiple tiers of networked stations is a virtual machine extension (VMX) for receiving, via said communication emulator a set of network data-objects for instantiating said development-environment emulator according to an event-driven data object included in said network data objects a development-environment emulator for emulating program executions in each of said multiple tiers of networked stations.

5. The integrated program development environment (IDE) of claim 4 wherein:
said local station further includes a data memory; and
said virtual machine extension (VMX) for receiving, via said communication emulator a set of network data-objects for performing a memory copy to said data-memory to instantiate said development-environment emulator according to said event-driven data object.

6. The integrated program development environment (IDE) of claim 5 wherein:
said virtual machine extension (VMX) further includes a data-object identification processing means and a data-object type processing means for processing a data-object identification and a data-object type contained in said event driven data object for each of said network data objects to perform a memory copy according to said data-object identification and said data-object type.

7. The integrated program development environment (IDE) of claim 1 wherein:
said development-environment emulator for emulating program execution environments in each of said multiple tiers of networked client-server stations further includes a network event instantiation driver emulator for emulating an event driven execution in each of said multiple tiers of networked client-server stations according said event-driven data object included in said network data objects.

8. The integrated program development environment (IDE) of claim 1 wherein:
said network event instantiation driver emulator further includes a Java virtual machine (JVM) emulator and a Web server emulator.

9. An integrated program development environment (IDE) comprising:
a concurrent program development means residing in a local station for executing programs emulating a multiple-tier networked client-server system interconnecting multiple tiers of client-server stations.

10. The integrated program development environment (IDE) of claim 9 wherein:
said concurrent program development means residing in a local station further including multiple emulated program execution environments for each of said client-server stations.

11. The integrated program development environment (IDE) of claim 9 wherein:
said concurrent program development means residing in a local station further including a communication emulator for emulating data-object transfers between said multiple tiers of client-server stations.

12. The integrated program development environment (IDE) of claim 9 wherein:
said concurrent program development means residing in a local station further includes tier-to-tier data-file compatibility handlers for processing data files generated from each of said multiple tiers of networked stations for compatible data-file transmissions and receptions with another one of said multiple tiers of networked stations.

13. The integrated program development environment (IDE) of claim 12 wherein:
each of said tier-to-tier data-file compatibility handlers for processing data files generated from each of said multiple tiers of networked stations is a virtual machine extension (VMX) for receiving, via said communication emulator a set of network data-objects for instantiating said development-environment emulator according to an event-driven data object included in said network data objects a development-environment emulator for emulating program executions in each of said multiple tiers of networked stations.

14. The integrated program development environment (IDE) of claim 13 wherein:
said local station further includes a data memory; and
said virtual machine extension (VMX) for receiving, via said communication emulator a set of network data-objects for performing a memory copy to said data-memory to instantiate said development-environment emulator according to said event-driven data object.

15. The integrated program development environment (IDE) of claim 14 wherein:
said virtual machine extension (VMX) further includes a data-object identification processing means and a data-object type processing means for processing a data-object identification and a data-object type contained in said event driven data object for each of said network data objects to perform a memory copy according to said data-object identification and said data-object type.

16. A method for carrying out concurrent program development tasks on a local station for programs executable on a multiple-tier networked client-server system with multiple tiers of client-server stations, the method comprising:
a) partitioning data objects into internal and external data objects for reducing a size of each of the network data objects;
b) providing interface connections to each of the internal and external data objects by including in each external data object an object identification and object type;
c) providing an association of the object identification and object type to one of the internal data objects for attaching the external data object thereto by a memory copy operation for instantiating a program execution, and
d) providing an integrated program development environment (IDE) in said local station emulating multiple program execution environments and data transfers of said internal and external data objects between said execution environments for instantiating said program execution to carry out said concurrent program development tasks.

17. The method of claim 16 further comprising a step of:
said step d) in emulating said program instantiation further includes a step of emulating a generation of an event-specific instance data object by emulating memory copying data from an internal data object to an associated external data object linking by the object identification and the data object type.

18. A data-handling system provided for emulating a network concurrent program development environment comprising:
multiple execution environment emulators each includes an event-driven data-object attachment-detachment processing means provided for responding to emulated network data-objects transferred between said execution environment emulator;
said data-handling system further includes data memory blocks addressable by pointers generated by said event-driven data-attachment-detachment processing means in response to said emulated network data-objects for performing a memory block copying for emulating a network concurrent program execution in said data handling system.

19. The data-handling system of claim 18 wherein:
said data memory blocks further includes a component object class name and a view object class name according to a type identification and a object name extracted from said network data object by said event-driven data-attachment-detachment processing means to instantiate a component object class and a view object class.

20. The data-handling system of claim 18 wherein:
said data memory blocks further includes a plurality of attribute definition blocks for allocating corresponding memory spaces for a component instance for performing a memory block copying of data blocks extracted from said network data object by said event-driven data-attachment-detachment processing means for emulating a network concurrent program execution in said data handling system.

21. The data-handling system of claim 18 wherein:
said data memory blocks further includes a method information block and an event information block associated with said type identification and said object name extracted from said network data object by said event-driven data-attachment-detachment processing means for providing method and event information for emulating a network concurrent program execution in said data handling system.
